(19) United States
(12) Patent Application Publication
(10) Pub. No.: US 2021/0307363 A1
(43) Pub. Date: Oct. 7, 2021

(54) Pet Food Compositions

(71) Applicant: Hill's Pet Nutrition, Inc., Topeka, KS (US)

(72) Inventors: Susan Wernimont, Lawrence, KS (US); Kathy Gross, Topeka, KS (US); Matthew Jackson, Topeka, KS (US); Andrew Stormer, Topeka, KS (US)

(73) Assignee: Hill's Pet Nutrition, Inc., Topeka, KS (US)

(21) Appl. No.: 17/301,532

(22) Filed: Apr. 6, 2021

Related U.S. Application Data
(60) Provisional application No. 63/005,959, filed on Apr. 6, 2020.

(51) Int. Cl. A23K 20/163; A23K 10/18; A23K 20/158; A23K 20/111; A23K 20/121; A23K 10/12

(52) U.S. Cl. CPC A23K 20/163; A23K 10/18; A23K 10/12; A23K 20/111; A23K 20/121; A23K 20/158

(57) ABSTRACT

Pet food compositions and methods for treating, inhibiting, reducing the severity of, or preventing diarrhea or constipation, improving stool characteristics, improving stooling behavior, and/or improving quality of life in a companion animal are disclosed. The pet food compositions may include psyllium or a derivative thereof, a polyphenol source, a high solubility fiber source, and a low solubility fiber source. The method may include administering an effective amount of the pet food composition to the companion animal in need thereof.

### BACKGROUND

Pets require a healthy diet and proper gastrointestinal motility for continued growth and ordinary wellbeing. In addition, abnormal gastrointestinal motility can interfere with the digestion of common pet food compositions and lead to constipation or diarrhea, which can be quite serious. Not only are these conditions extremely unpleasant to the pets harboring the condition, but they can also create problems for the pet owner who cares for the pet, more particularly if the conditions are chronic.

While certain ingredients are known to be effective in increasing stool firmness, there remains a need for ingredients, and pet food compositions, that: 1) treat, prevent, and/or inhibit constipation and/or diarrhea; and 2) improve stool characteristics, stooling behaviors, and quality of life in companion animals.

What is needed, then, are improved pet food compositions and methods for treating, preventing, or inhibiting diarrhea/constipation, improving stool characteristics, and/or improving stooling behavior.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a pet food composition including psyllium or a derivative thereof, a polyphenol source, a high solubility fiber source, and a low solubility fiber source.

In at least one implementation, the psyllium or derivative thereof, may be present in an amount of from about 0.1 wt % to about 5 wt %, optionally from about 0.5 wt % to about 2.5 wt %, or from about 1 wt % to about 2 wt %, of the composition; further optionally about 1.1 wt %, about 1.2 wt. %, about 1.3 wt %, about 1.4 wt %, about 1.5 wt %, about 1.6 wt %, about 1.7 wt %, about 1.8 wt %, or about 1.9 wt %, based on the total weight of the pet food composition.

In at least one implementation, the high solubility fiber source may include one or more of oat bran, buckwheat groats, barley, tomato pomace, flaxseed, citrus pulp, beet pulp, or combinations thereof, more preferably, oat bran, buckwheat groats, barley, flaxseed, citrus pulp, beet pulp, or combinations thereof.

In at least one implementation, the high solubility fiber source may include one or more of oat bran, buckwheat groats, barley, flaxseed, tomato pomace, citrus pulp, beet pulp, or combinations thereof.

In at least one implementation, the low solubility fiber source may include one or more of a cellulosic material, a pecan fiber, or combinations thereof.

In at least one implementation, the pet food composition may further include from about 15 wt % to about 55 wt % protein, about 20 wt % to about 55 wt % protein, optionally from about 32 wt % to about 38 wt % protein, further optionally about 33 wt %, about 34 wt %, about 35 wt %, about 36 wt % or about 37 wt % protein.

In at least one implementation, the pet food composition may further include from about 5 wt % to about 15 wt % total dietary fiber, optionally from about 8 wt % to about 14 wt % total dietary fiber, further optionally about 9 wt %, about 10 wt %, about 11 wt %, about 12 wt % or about 13 wt % total dietary fiber.

In at least one implementation, the pet food composition may include a weight ratio of insoluble fiber to soluble fiber of from about 10:1 to about 1:1, optionally about 7.5:1 to about 2.5:1, further optionally about 5:1.

In at least one implementation, the pet food composition may further include a mixture of omega-6 fatty acids and omega-3 fatty acids. In at least one implementation, the weight ratio of the omega-6 fatty acids to the omega-3 fatty acids may be from about 10:1 to about 1:1, optionally about 7.5:1 to about 2:1, further optionally about 3.5:1. In at least one implementation, the omega-3 fatty acids may include from about 0.1 wt % to about 0.5 wt % docosahexaenoic acid (DHA), eicosapentaenoic acid (EPA), or a mixture thereof, optionally about 0.3 wt % to about 0.4 wt %, further optionally about 0.31 wt %, about 0.32 wt %, about 0.33 wt %, about 0.34 wt %, about 0.35 wt %, about 0.36 wt %, about 0.37 wt %, about 0.38 wt %, or about 0.39 wt %. In at least one implementation, the omega-3 fatty acids may be provided by flaxseed.

In at least one implementation, the polyphenol source may provide a polyphenol selected from one or more of dehydroxy rosmarinic acid, Coumaroylnepitrin, eupafolin, carnosol, scutellarin, kaempferol, rosmarinic acid, rosmanol, cirsimaritin, luteolin, 6-methoxy-luteolin, 7-epirosmannol, quercetin, catechin, hesperidin, cyanidin, or combinations thereof.

In at least one implementation, the polyphenol source may include pressed cranberries.

In at least one implementation, the polyphenol source may include cranberry pomace.

In at least one implementation, the pet food composition may be free or substantially free of pea fiber.

In at least one implementation, the pet food composition may further include pumpkin.

In at least one implementation, the pet food composition may further include a probiotic. The probiotic may include one or more of Bifidobacterium lactis; Bifidobacterium animalis; Lactobacillus acidophilus; Bifidobacterium longum; Enterococcus faecium; or combinations thereof.

In at least one implementation, the pet food composition may further include a prebiotic. The prebiotic may include a fructooligosaccharide.

The foregoing and/or other aspects and utilities embodied in the present disclosure may be achieved by providing a method for treating, inhibiting, or preventing diarrhea or constipation; improving stool characteristics; improving stooling behaviors; and/or improving quality of life in a companion animal. The method may include administering an effective amount of any one of the pet food compositions disclose herein to the companion animal in need thereof. For example, the method may include administering an effective amount of a pet food composition including psyllium or a derivative thereof, a polyphenol source, a high solubility fiber source, and a low solubility fiber source to the companion animal in need thereof.

Further areas of applicability of the present disclosure will become apparent from the detailed description provided hereinafter. It should be understood that the detailed description and specific examples, while indicating some typical aspects of the disclosure, are intended for purposes of illustration only and are not intended to limit the scope of the disclosure.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a plot or graphical representation of stool blood observed in companion animals for Example 2.

FIG. 2 illustrates a plot or graphical representation of stool blood observed in companion animals for Example 3.

FIG. 3 illustrates a plot or graphical representation of stool mucus observed in companion animals for Example 4.

FIG. 4 illustrates a plot or graphical representation of stool mucus observed in companion animals for Example 5.

### DETAILED DESCRIPTION

The following description of various typical aspect(s) is merely exemplary in nature and is in no way intended to limit the disclosure, its application, or uses.

As used throughout this disclosure, ranges are used as shorthand for describing each and every value that is within the range. It should be appreciated and understood that the description in a range format is merely for convenience and brevity, and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Unless otherwise specified, all percentages and amounts expressed herein and elsewhere in the specification should be understood to refer to percentages by weight. The amounts given are based on the active weight of the material.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

As used herein, “free” or “substantially free” of a material may refer to a composition, component, or phase where the material is present in an amount of less than 10.0 weight %, less than 5.0 weight %, less than 3.0 weight %, less than 2.0 wt %, less than 1.5 wt %, less than 1.0 weight %, less than 0.5 wt %, less than 0.25 wt %, less than 0.1 weight %, less than 0.05 weight %, less than 0.01 weight %, less than 0.005 weight %, or less than 0.0001 weight % based on a total weight of the composition, component, or phase.

All references cited herein are hereby incorporated by reference in their entireties. In the event of a conflict in a definition in the present disclosure and that of a cited reference, the present disclosure controls.

The present inventors have surprisingly and unexpectedly discovered that pet food compositions including a combination of plant fibers including antioxidant and polyphenol compounds treat, prevent, and/or inhibit constipation and/or diarrhea in companion animals. Specifically, the present inventors have surprisingly and unexpectedly discovered that pet food compositions including a combination of psyllium or a derivative thereof, a polyphenol source, a high solubility fiber source, and a low solubility fiber source treat, prevent, and/or inhibit constipation and diarrhea in companion animals.

### Compositions

Pet food compositions are disclosed herein. The pet food compositions may include psyllium and/or a derivative thereof, a polyphenol source, a high solubility fiber source, a low solubility fiber source, or combinations thereof. The combination of the psyllium and/or the derivative thereof, the polyphenol source, the high solubility fiber source, and/or the low solubility fiber source, may be capable of or configured to treat, prevent, and/or inhibit diarrhea or constipation. The combination of the psyllium and/or the derivative thereof, the polyphenol source, the high solubility fiber source, and/or the low solubility fiber source, may be present in an amount effective to treat, prevent, and/or inhibit diarrhea or constipation.

Dietary fiber sources may be or include plant materials in a pet food composition or a diet of a companion animal that are resistant to enzymatic digestion. Dietary fiber sources may include, but are not limited to, cellulose, noncellulosic polysaccharides (e.g., hemicellulose, pectin, substances, gums, mucilages, etc.), lignin, or combinations thereof. Dietary fiber sources may be divided into at least two groups based on their solubility in aqueous buffer solutions at a specific or predetermined pH. The specific pH or predetermined pH may be determined by one having ordinary skill in the art. The two groups of the dietary fiber sources may be or include high solubility fibers and low solubility or insoluble fibers. A high solubility fiber source may be or include fibers or fiber components including pectin, gums, mucilages, or combinations thereof. A high solubility fiber source may be or include soluble fibers. A low solubility or insoluble fiber may be or include fibers or fiber components that include cellulose, hemi-cellulose, lignin, or combinations thereof.

In at least one implementation, the high solubility fiber source may include one or more of gums (e.g., guar, locust bean, etc.), mucilages (e.g., acacia, karaya, tragacanth, aloe vera, fenugreek, flaxseeds, plantains, etc.), seaweeds (e.g., alginates, carrageenan, etc.), pectins (e.g., apple, pear, guava, quince, plum, gooseberry, oranges and other citrus fruit, potatoes, sugar beet, etc.), other fiber sources such as buckwheat groats, whole grain oats, whole grain corn, whole grain barley, citrus pulp, beet pulp, pumpkin, or combinations thereof. In at least one implementation, the low solubility fiber source may include one or more of a cellulosic material, a pecan fiber, or combinations thereof. In an exemplary implementation, the pet food composition may be free or substantially free of pea fiber. The cellulosic material may be or include, but is not limited to, purified cellulose from brans, oats and other cereal grains, peas and other legumes, tomato pomace, woody species (trees, bamboo fiber, etc), roots (carrots, beets, sweet potatoes, yams, etc.), pears, apples, or combinations thereof.

As discussed above, the pet food composition may include psyllium and/or a derivative thereof. Illustrative derivatives of psyllium may be or include, but are not limited to, psyllium husk, psyllium seeds, psyllium seed husks, powdered psyllium, or combinations thereof. Any one of the derivatives of psyllium or psyllium may be utilized alone or in combination with other compounds or substances to prepare powders, gels, gums, or other forms, or combinations thereof.

In at least one implementation, the psyllium and/or derivatives thereof may be present in the pet food composition in an amount of from about 0.1 wt % to about 5 wt %, based on the total weight of the pet food composition. For example, the psyllium and/or derivatives thereof may be present in the pet food composition in an amount of from about 0.1 wt % to about 5 wt %, optionally, from about 0.5 wt % to about 2.5 wt %, or from about 1 wt % to about 2 wt %, based on the total weight of the pet food composition. In another example, the psyllium and/or derivatives thereof may be present in the pet food composition in an amount of about 1.1 wt %, about 1.2 wt %, about 1.3 wt %, about 1.4 wt %, about 1.5 wt %, about 1.6 wt %, about 1.7 wt %, about 1.8 wt %, or about 1.9 wt %, based on the total weight of the pet food composition. In a preferred implementation, the psyllium and/or derivatives thereof may be present in the pet food composition in an amount of from about 1.3 wt % to about 1.7 wt %, about 1.4 wt % to about 1.6 wt %, or about 1.5 wt %, based on the total weight of the pet food composition.

In at least one implementation, the pet food composition may include protein in an amount of from about 30 wt % to about 55 wt %, based on the total weight of the pet food composition. For example, the pet food composition may include protein in an amount of from about 30 wt % to about 40 wt %, about 30 wt % to about 55 wt %, about 32 wt % to about 38 wt %, about 32 wt % to about 45 wt %, based on the total weight of the pet food composition. In another example, the pet food composition may include protein in an amount of about 33 wt %, about 34 wt %, about 35 wt %, about 36 wt % about 37 wt %, about 38 wt %, about 39 wt %, about 40 wt %, about 42 wt %, about 44 wt %, about 46 wt %, about 48 wt %, about 50 wt %, about 52 wt %, about 54 wt %, or about 55 wt %, based on the total weight of the pet food composition.

In at least one implementation, the pet food composition may include total dietary fiber in an amount of from about 5 wt % to about 15 wt %, based on the total weight of the pet food composition. For example, the pet food composition may include total dietary fiber in an amount of from about 5 wt % to about 15 wt %, about 8 wt % to about 14 wt %, about 9 wt %, about 10 wt %, about 11 wt %, about 12 wt %, or about 13 wt %, based on the total weight of the pet food composition.

In at least one implementation, a weight ratio of the insoluble fiber to the soluble fiber may be from about 10:1 to about 1:1. For example, the weight ratio of the insoluble fiber to the soluble fiber in the pet food composition may be from about 10:1 to about 1:1, about 7.5:1 to about 2.5:1, about 7.5:1 to about 2:1, or about 5:1.

In at least one implementation, the pet food composition may include omega-6 fatty acids, omega-3 fatty acids, or combinations thereof. In an exemplary implementation, the pet food composition includes a mixture of omega-6 fatty acids and omega-3 fatty acids. A weight ratio of the omega-6 fatty acids to the omega-3 fatty acids may be from about 10:1 to about 1:1. For example, the weight ratio of the omega-6 fatty acids to the omega-3 fatty acids may be from about 10:1 to about 1:1, about 7.5:1 to about 2:1, or about 3.5:1. In at least one implementation, the omega-3 fatty acids may include docosahexaenoic acid (DHA), eicosapentaenoic acid (EPA), or combinations thereof. The omega-3 fatty acids may include DHA and/or EPA in an amount of from about 0.1 wt % to about 0.5 wt %. For example, the omega-3 fatty acids may include DHA and/or EPA in an amount of from about 0.1 wt % to about 0.5 wt %, about 0.3 wt % to about 0.4 wt %, optionally, about 0.31 wt %, about 0.32 wt %, about 0.33 wt %, about 0.34 wt %, about 0.35 wt %, about 0.36 wt %, about 0.37 wt %, about 0.38 wt %, or about 0.39 wt %. In at least one implementation, the omega-3 fatty acids are provided by flaxseed.

In at least one implementation, the polyphenol source includes one or more polyphenols. The polyphenol may be or include, but is not limited to, one or more of enterodiol, narigenin, secoisolariciresinol, eriodictyol, apigenin, chrysin, chrysoeriol, coumestrol, daidzein, dihydroferulate, dihydrokaempferol, diosmetin, eriodictyol, ferulate, feruloylputrescine, genistein, glycitein, hesperidin, kaempferol, matairesinol, narirutin, neoponcirin, secoisolariciresinol diglucoside, sinapate, sinensetin, syringic acid, tangeritin, tetramethyl-o-scutellarin, tyrosol, vanillate or combinations thereof. In an exemplary implementation, the polyphenol source includes flaxseed, whole berries, dried berries, pressed berries, berry pomaces, tea extract, rosemary extract, rosemarinic acid, coffee extract, pecan shells, caffeic acid, turmeric extract, blueberry extract, grape extract, grapeseed extract, soy extract, or the like, or combinations thereof. Illustrative berries may be or include, but are not limited to, cranberries, blueberries, cherries, elderberries, blackberries, raspberries, or the like, or combinations thereof.

In at least one implementation, the pet food composition may include pumpkin. The pumpkin may be present in an amount of from about 0.1 wt % to about 30 wt %, optionally from about 0.2 wt % to about 20 wt %, or from about 0.5 wt % to about 15 wt %, based on the total weight of the pet food composition. The pumpkin may provide a source of both soluble and insoluble fiber. The pumpkin may be capable of or configured to at least partially prevent, treat, or inhibit diarrhea or constipation. The pumpkin may be provided as a precooked pumpkin puree having a relatively high moisture content, as a powder, such as from a whole pumpkin that has been dried and ground into a powder, or combinations thereof.

The pet food composition may include one or more additives. The one or more additives may include additives known in the art. Illustrative additives may be or include but are not limited to, substances with a stabilizing effect or stabilizing substances, organoleptic substances, processing aids, substances that provide nutritional benefits, or combinations thereof. The additives may be present in an amount that does not impair the purpose and effect of the pet food composition. For example, the additives may be present in an amount that does not affect the treatment, prevention, and/or inhibition of diarrhea and/or constipation, the improved stool characteristics, the improved stooling behavior, the improved quality of life of the companion animal, or combinations thereof.

The stabilizing substances may be capable of or configured to increase the shelf life of the pet food composition. Illustrative stabilizing substances may be or include, but are not limited to, one or more of preservatives, antioxidants, synergists and sequestrants, packaging gases, stabilizers, emulsifiers, thickeners, gelling agents, humectants, or combinations thereof. Examples of emulsifiers and/or thickening agents or thickeners may be or include, but are not limited to, one or more of gelatin, cellulose ethers, starch, starch esters, starch ethers, modified starches, or combinations thereof.

The additives for coloring, palatability, and/or nutritional purposes may include colorants, salts, vitamins, minerals, flavoring, or combinations thereof. The amount of such additives in the pet food composition may be up to about 5 wt % on a dry matter basis of the composition. Other additives may include antioxidants, omega-3 fatty acids, omega-6 fatty acids, glucosamine, chondroitin sulfate, vegetable extracts, herbal extracts, or the like, or combinations thereof. The salts may be or include, but are not limited to, sodium chloride, potassium citrate, potassium chloride, other edible salts, or the like, or combinations thereof.

In at least one implementation, the pet food composition may include vitamins and minerals in an amount sufficient to avoid deficiencies and to maintain health. The sufficient amounts are readily known in the art. For example, the Association of American Feed Control Officials (AAFCO) provides recommended amounts of such nutrients for dogs and cats (see Association of American Feed Control Officials. Official Publication, pp. 126-140 (2003)).

The vitamins may be or include, but are not limited to, one or more vitamin A, vitamin B1 (thiamine or related sources such as thiamine mononitrate), vitamin B2 (riboflavin), vitamin B3 (niacin), vitamin B5 (pantothenic acid or related sources such as calcium pantothenate), vitamin B6 (pyridoxine or related sources such as pyridoxine hydrochloride), vitamin B8 (folic acid), vitamin B12, vitamin C (ascorbic acid), vitamin D (such as a vitamin D3 supplements), vitamin E, vitamin H (biotin), vitamin K, acetate, choline and choline related sources such as choline chloride, inositol, or the like, or combinations thereof.

Illustrative minerals and trace elements may be or include, but are not limited to, one or more of calcium, phosphorus, sodium, potassium, magnesium, copper, zinc, choline, iron salts, or combinations thereof. Mineral sources or sources of the minerals and/or trace elements may be or include, but are not limited to, sodium selenite, monosodium phosphate, calcium carbonate, potassium chloride, ferrous sulfate, zinc oxide, manganese sulfate, copper sulfate, manganous oxide, potassium iodide, cobalt carbonate, or combinations thereof.

The pet food compositions disclosed herein may include carbohydrates. As used herein, the term “carbohydrate” may include polysaccharides (e.g., starches and dextrins) and sugars (e.g., sucrose, lactose, maltose, glucose, and fructose) that are metabolized for energy when hydrolyzed. Illustrative carbohydrates suitable for inclusion in the pet food compositions disclosed herein may include, but are not limited to, one or more of corn, grain sorghum, wheat, barley, rice, or the like, or combinations thereof.

In at least one implementation, the carbohydrate component or the carbohydrate may include one or more carbohydrate sources. In an exemplary implementation, the carbohydrate may include a mixture or combination of two or more carbohydrate sources. Illustrative carbohydrates, carbohydrate sources, or carbohydrate ingredients may be or include, but are not limited to, one or more of cereals, grains, corn, wheat, rice, oats, corn grits, sorghum, grain sorghum/milo, wheat bran, oat bran, amaranth, Durum, semolina, or the like, or combinations thereof.

It should be appreciated that one having ordinary skill in the art could manipulate the texture of a final product or the pet food composition by properly balancing the one or more carbohydrate sources or carbohydrates thereof. For example, short chain polysaccharides tend to be sticky and gluey, and longer chain polysaccharides tend to be relatively less sticky and gluey than the short chain polysaccharides. In at least one implementation, a desired texture of the pet food composition is achieved by longer chain polysaccharide and modified starches, such as native or modified starches, cellulose, or the like, or combinations thereof.

In at least one implementation, the carbohydrate mixture may additionally include optional components, such as added salt, spices, seasonings, vitamins, minerals, flavorants, colorants, or the like, or combinations thereof. The amount of the optional additives may be at least partially dependent on the nutritional requirements for different life stages of animals.

The pet food composition may include fat or fats in an amount of from about 10 wt % to about 14 wt %, based on the total weight of the pet food composition. Sources of fat or fat sources may be or include, but are not limited to, one or more of poultry fat, chicken fat, turkey fat, pork fat, lard, tallow, beef fat, vegetable oils, corn oil, soy oil, cottonseed oil, palm oil, palm kernel oil, linseed oil, canola oil, rapeseed oil, fish oil, menhaden oil, anchovy oil, olestra, or the like, or combinations thereof.

The pet food composition may include protein. As used herein, the term “protein” may refer to a polypeptide, or a peptide, or a polymer of amino acids. The term encompasses naturally occurring and non-naturally occurring (synthetic) polymers and polymers in which artificial chemical mimetics are substituted for one or more amino acids (e.g., peptidomimetic). Peptidomimetic may refer to small protein-like chain designed to mimic a peptide that may arise either from modification of an existing peptide, or by designing similar systems that mimic peptides, such as peptoids and beta-peptides. The term also encompasses fragments, variants, and homologs that have the same or substantially the same properties and perform the same or substantially the same function as the original sequence. The term encompasses polymers of any length, including polymers containing from about 2 to 1000, from about 4 to about 800, from about 6 to about 600, and from about 8 to about 400 amino acids. The term includes amino acid polymers that are synthesized and that are isolated and purified from natural sources. In at least one implementation, the terms “polypeptide,” “peptide,” or “protein” may be used interchangeably.

The protein may be present in an amount of from about 15 wt % to about 55 wt %, based on the total weight of the pet food composition. For example, the protein may be present in an amount of from about 15 wt % to about 55 wt %, about 30 wt % to about 55 wt % protein, optionally from about 32 wt % to about 38 wt % protein, further optionally about 33 wt %, about 34 wt %, about 35 wt %, about 36 wt % or about 37 wt %, based on the total weight of the pet food composition.

Protein may be supplied by any of a variety of sources known by those of ordinary skill in the art including plant sources, animal sources, or combinations thereof. The animal sources may be or include, but are not limited to, meat, meat-by products, seafood, dairy, eggs, or the like, or combinations thereof. Illustrative meats may be or include, but are not limited to, animal flesh such as poultry fish, and mammals including cattle, pigs, sheep, goats, or the like, or combinations thereof. Meat by-products may be or include, but are not limited to, any secondary product from a primary food processing line. Meat by-products may also be or include, but are not limited to ingredients that are typically not used in human consumption, for example, lungs, kidneys, brain, livers, hearts, stomachs and intestines. Plant protein may be or include, but are not limited to, soybean, cottonseed, beans, corn, peanuts, or the like, or combinations thereof.

Illustrative protein or protein ingredients may be or include, but are not limited to, chicken meals, chicken, chicken by-product meals, lamb, lamb meals, turkey, turkey meals, beef, beef by-products, viscera, fish meal, hill, krill meals, kangaroo, white fish, venison, soybean meal, soy protein isolate, soy protein concentrate, corn gluten meal, corn protein concentrate, distillers dried grains, and/or distillers dried grain solubles, insects, insect meals, and single-cell proteins, for example yeast, algae, and/or bacteria cultures.

The protein may be intact, completely hydrolyzed, or partially hydrolyzed. The protein content of the pet food composition may be determined by any number of methods known by those of skill in the art; for example, determination via method 988.05, as published by the Association of Official Analytical Chemists in Official Methods of Analysis (“OMA”). The amount of protein in the pet food composition may be determined based on the amount of nitrogen in the pet food composition according to methods familiar to one of skill in the art.

Illustrative amino acids may be or include, but are not limited to, 1-Tryptophan, Taurine, Histidine, Carnosine, Alanine, Cysteine, Arginine, Methionine, Tryptophan, Lysine, Asparagine, Aspartic acid, Phenylalanine, Valine, Threonine, Isoleucine, Histidine, Leucine, Glycine, Glutamine, Tyrosine, Homocysteine, Ornithine, Citrulline, Glutamic acid, Proline, Serine, or combinations thereof.

The pet food composition may include one or more carotenoids. The carotenoids or sources of the carotenoids may be or include, but are not limited to, lutein, astaxanthin, zeaxanthin, bixin, lycopene, beta-carotene, or combinations thereof.

The pet food composition may include one or more fatty acids or fatty acid ingredients. The one or more fatty acids or fatty acid ingredients may be or include, but are not limited to, one or more of arachidonic acid, alpha-linolenic acid, gamma linolenic acid, linoleic acid, lauric acid, myristic acid, eicosapentaenoic acid (EPA), docosahexaenoic acid (DHA), fish oils as a source of EPA and/or DHA, or combinations thereof.

The pet food composition may include one or more glucose mimetics. The glucose mimetics may be or include, but are not limited to, one or more of glucose anti-metabolites including 2-deoxy D-glucose, 5-thio-D-glucose, 3-O-methylglucose, anhydrosugars including 1,5-anhydro-D-glucitol, 2,5-anhydro-D-glucitol, and 2,5-anhydro-D-mannitol, mannoheptulose, avocado extract comprising mannoheptulose, or combinations thereof.

The pet food composition may include any one or more of beef broth, fish broth, poultry broth, brewers dried yeast, egg, egg product, flax meal, DL methionine, amino acids, leucine, lysine, arginine, cysteine, cystine, aspartic acid, polyphosphates, sodium pyrophosphate, sodium tripolyphosphate; zinc chloride, copper gluconate, stannous chloride, stannous fluoride, sodium fluoride, triclosan, glucosamine hydrochloride, chondroitin sulfate, green lipped mussel, blue lipped mussel, methyl sulfonyl methane (MSM), boron, boric acid, phytoestrogens, phytoandrogens, genistein, diadzein, Lcarnitine, chromium picolinate, chromium tripicolinate, chromium nicotinate, acid/base modifiers, potassium citrate, potassium chloride, calcium carbonate, calcium chloride, sodium bisulfate; eucalyptus, lavender, peppermint, plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), antifoaming agents (such as silicone), preservatives (such as butylated hydroxytoluene (BHT) and butylated hydroxyanisole (BHA), propyl gallate, benzalkonium chloride, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, keratolytics, or the like, or combinations thereof.

The pet food composition may include one or more probiotics or probiotic components. Illustrative probiotics or probiotic components may be or include, but are not limited to, one or more of any suitable bacteria, yeast, microorganisms, or combinations thereof. Various probiotic microorganisms are known in the art. In at least one implementation, the probiotic component may be or include, but is not limited to, bacteria of the order Lactobacillales; bacteria of the genus Bacillus, Bacteroides, and/or Bifidobacterium; yeast of the order Saccharomycetales including the genus Saccharomyces and Candida; or combinations thereof. The probiotic may or may not form a spore.

The pet food composition may include one or more prebiotics or prebiotic components. Any one or more prebiotics or prebiotic components known in the art may be utilized. In an exemplary implementation, the pet food composition includes fructooligosaccharide.

Illustrative bacteria of the order Lactobacillales suitable for use herein may be or include, but is not limited to, the genus Streptococci, such as Streptococcus lactis, Streptococcus cremoris, Streptococcus diacetylactis, and/or Streptococcus thermophilus; the genus Enterococcus, such as Enterococcus faecium, the family Lactobacillillaceae including the genus Pediococcus (i.e. Pediococcus cerevisiae), the genus Leuconostroc, and the genus Lactobacilli such as Lactobacillus bulgaricus, Lactobacillus acidophilus, Lactobacillus helveticus, Lactobacillus bifidus, Lactobacillus casei, Lactobacillus lactis, Lactobacillus plantarum, Lactobacillus rhamnosus, Lactobacillus delbrukii, Lactobacillus therrnophilus, Lactobacillus fermentii, Lactobacillus salvarius, Lactobacillus reuteri, and/or mixtures of any thereof. Nonlimiting examples of bacteria of the genus Bifidobacteria include Bifidobacterium longum, Bifidobacterium infantis, Bifidobacterium bifidum, Bifidobacterium animalis, and/or Bifidobacterium pseudolongum; or combinations thereof.

In at least one implementation, the pet food composition includes one or more polyphenols. The source of polyphenol or the polyphenol source may be or include, but is not limited to, a phenolic compound, including, one or more of apigenin, enterodiol, naringenin, chrysin, chrysoeriol, coumestrol, daidzein, dihydroferulate, dihydrokaempferol, diosmetin, eriodictyol, ferulate, feruloylputrescine, genistein, glycitein, hesperidin, kaempferol, matairesinol, narirutin, neoponcirin, secoisolariciresinol diglucoside, sinapate, sinensetin, syringic acid, tangeritin, tetramethyl-o-scutellarin, tyrosol, vanillate; or combinations thereof. The polyphenol source may be or include, but is not limited to, one or more of pecan shells, any other component of the pecan nut, or combinations thereof. In at least one implementation, the pecan shell may also be a source of lignin-based fiber. Illustrative sources of polyphenol may also be or include, but are not limited to, flaxseed, whole berries, dried berries, pressed berries, berry pomaces, or the like, as discussed above, tea extract, rosemary extract, rosemarinic acid, coffee extract, pecan shells, caffeic acid, turmeric extract, blueberry extract, grape extract, grapeseed extract, soy extract, or combinations thereof.

The pet food composition may include crude fat or fat. The crude fat or cat may be provided or supplied by any of a variety of sources known by those skilled in the art. Illustrative sources of fat and/or crude fat may be or include, but are not limited to, meat, meat by-products, fish oil, plants, or the like, or combinations thereof. The plant fat sources or sources of plant fat may be or include, but are not limited to, one or more of wheat, flaxseed, rye, barley, rice, sorghum, corn, oats, millet, wheat germ, corn germ, soybeans, peanuts, cottonseed, as well as oils derived from these and other plant fat sources, or the like, or combinations thereof. It should be appreciated that the amount of fat or fat content of the pet food composition may be determined by any number of methods known by those having ordinary skill in the art.

The pet food composition may include ash. Ash may be or include compounds that are not organic or water, minerals, generally produced by the combustion of biological materials. It should be appreciated that the amount of ash or ash content of the pet food composition may be determined by any number of methods known by those having ordinary skill in the art.

The pet food composition may include moisture or water. The amount of moisture or water present in the pet food composition may be at least partially dependent on the type of pet food composition. For example, the pet food composition may be in the form of a dry kibble, a semi-moist food, or a wet loaf or wet food. The dry kibble may have a moisture content of from about 6 wt % to about 12 wt %, the semi-moist food may have a moisture content of from about 15 wt % to about 30 wt %, and the wet food may have a moisture content greater than the semi-moist food, such as a moisture content of greater than about 30 wt %, greater than about 50 wt %, greater than about 60 wt % to about 85 wt %, or about 75 wt %.

In at least one implementation, the pet food composition may include one or more additional ingredients, such as, one or more of vitamins, minerals, fillers, palatability enhancers, binding agents, flavors, stabilizers, emulsifiers, sweeteners, colorants, buffers, salts, coatings, or the like, or combinations thereof. Stabilizers may include substances that tend to increase the shelf life of the composition, such as preservatives, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches. Specific amounts for each composition component, food ingredient, and other ingredients will depend on a variety of factors such as the particular components and ingredients included in the composition; the species of patient or pet; the pet or patient's age, bodyweight, general health, sex, and diet; the pet's consumption rate; the type of disease being treated; or the like, or combinations thereof. Therefore, the component and ingredient amounts may vary widely and may deviate from the preferred proportions described herein.

In at least one implementation, the pet food is a dry pet food. The pet food composition may be prepared in a dry form using conventional processes known to skilled artisans. Typically, dry ingredients such as animal protein, plant protein, grains, and the like are ground and mixed together. Moist or liquid ingredients, including fats, oils, animal protein, water, and the like, are then added and mixed with the dry mix. The mixture may then be processed into dry food pieces.

The pet food composition described herein may be in any form useful for feeding the composition to a patient, a pet, or a companion animal. For example, the pet food composition may be in the form of kibbles, treats, toys for animal food, or the like, or combinations thereof. Kibbles are generally formed using an extrusion process in which the mixture of dry and wet ingredients is subjected to mechanical work at a high pressure and temperature and forced through small openings and cut off into kibble by a rotating knife. The wet kibble is then dried and optionally coated with one or more topical coatings such as flavors, fats, oils, powders, and the like. Kibble also can be made from the dough using a baking process, rather than extrusion, wherein the dough is placed into a mold before dry-heat processing.

Treats may include compositions that are given to the pet or companion animal to entice the animal to eat during a non-meal time. Treats may be nutritional such that the composition thereof may include one or more nutrients and/or a food-like composition. Non-nutritional treats encompass any other treats that are non-toxic. The composition or components thereof may be coated onto the treat, incorporated into the treat, or both. Treats may be prepared by an extrusion or baking process similar to those used for dry food. Other processes also may be used to either coat the composition on the exterior of existing treat forms or inject the composition into an existing treat form.

Toys include chewable toys, such as artificial bones and food compositions shaped to resemble natural foods that are appealing to the animal. The pet food composition may include the toy or may form a portion of the toy. For example, the pet food composition may form a coating on the surface of the toy or on the surface of a component of the toy. The pet food composition may be incorporated partially or fully throughout the toy or both. In at least one implementation, the pet food composition may be orally accessible by the intended user. The pet food composition may include partially consumable toys, such as toys including plastic components, and fully consumable toys, such as various artificial bones and similar foods. Further, the toys may be for both human and non-human use, particularly toys for companion, farm, and zoo animal use, and more particularly for feline and canine use.

In at least one implementation, the pet food compositions disclosed herein include psyllium or a derivative thereof, a polyphenol source, a high solubility fiber source, and a low solubility fiber source. The psyllium or derivative thereof may be present in an amount of from about 0.1 wt. % to about 5 wt. %, optionally from about 0.5 wt. % to about 2.5 wt. %, or from about 1 wt. % to about 2 wt. %. The high solubility fiber source may include one or more of oat bran, buckwheat groats, barley, tomato pomace, citrus pulp, beet pulp, or combinations thereof, more preferably, the high solubility fiber source includes one or more of oat bran, buckwheat groats, barley, citrus pulp, beet pulp, or combinations thereof. The low solubility fiber source may include one or more of a cellulosic material, a pecan fiber, or combinations thereof. In at least one implementation, the pet food composition may further include protein. The protein may be present in an amount of from about 30 wt % to about 55 wt % protein, optionally from about 32 wt % to about 38 wt % protein, further optionally about 33 wt %, about 34 wt %, about 35 wt %, about 36 wt % or about 37 wt %, based on the total weight of the pet food composition. The pet food composition may further include dietary fiber in an amount of from about 5 wt % to about 15 wt %, optionally from about 8 wt % to about 14 wt %, further optionally, about 9 wt %, about 10 wt %, about 11 wt %, about 12 wt % or about 13 wt %, based on the total weight of the pet food composition. In at least one implementation, a weight ratio of insoluble fiber to soluble fiber is from about 10:1 to about 1:1, optionally, about 7.5:1 to about 2.5:1, further optionally, about 5:1. In a preferred implementation, the pet food composition includes a mixture of omega-6 fatty acids and omega-3 fatty acids. A weight ratio of the omega-6 fatty acids to the omega-3 fatty acids is from about 10:1 to about 1:1, optionally, about 7.5:1 to about 2:1, further optionally, about 3.5:1. In at least one implementation, the omega-3 fatty acids includes from about 0.1 wt % to about 0.5 wt % docosahexaenoic acid (DHA), eicosapentaenoic acid (EPA), or a mixture thereof, optionally, about 0.3 wt % to about 0.4 wt %, further optionally, about 0.31 wt %, about 0.32 wt %, about 0.33 wt %, about 0.34 wt %, about 0.35 wt %, about 0.36 wt %, about 0.37 wt %, about 0.38 wt %, or about 0.39 wt %. In one implementation, the polyphenol source provides a polyphenol selected from one or more of dehydroxy rosmarinic acid, Coumaroylnepitrin, eupafolin, carnosol, scutellarin, kaempferol, rosmarinic acid, rosmanol, cirsimaritin, luteolin, 6-methoxy-luteolin, 7-epirosmannol, quercetin, catechin, hesperidin, cyanidin, or combinations thereof. The polyphenol source includes pressed cranberries, cranberry pomace, or combinations thereof, more preferably, the polyphenol source includes pressed cranberries. In at least one example, the pet food composition may further include pumpkin.

In at least one implementation, the pet food compositions disclosed herein includes protein in an amount of about 30 wt % to about 40 wt %, about 34 wt % to about 38 wt %, or about 36 wt %; fat in an amount of about 15 wt % to about 25 wt %, about 18 wt % to about 22 wt %, or about 20 wt %; total dietary fiber in an amount of about 8 wt % to about 16 wt %, about 10 wt % to about 14 wt %, or about 12 wt %, where the dietary fiber includes soluble fiber and insoluble fiber, and where the soluble fiber is present in an amount of from about 0.5 wt % to about 3.5 wt %, about 1 wt % to about 3 wt %, or about 2 wt %, and the insoluble fiber is present in an amount of from about 7 wt % to about 13 wt %, about 8 wt % to about 12 wt %, or about 10 wt %; omega-6 fatty acids in an amount of from about 1 wt % to about 5 wt %, about 2 wt % to about 4 wt %, or about 3.5 wt %; and omega-3 fatty acids in an amount of about 0.5 wt % to about 1.5 wt %, or about 1.0 wt %; where the omega-3 fatty acid may include EPA and DHA in an amount of from about 0.1 wt % to about 0.5 wt %, about 0.2 wt % to about 0.4 wt %, or about 0.35 wt %.

In an exemplary implementation, the pet food composition further includes a mixed fiber source including one or more of ground pecan shells, beet pulp, flaxseed, citrus pulp, pressed cranberries, pea fiber, pumpkin, fructooligosaccharides, psyllium seed husk, or combinations thereof. In a preferred implementation, the mixed fiber source including a combination of ground pecan shells, beet pulp, flaxseed, citrus pulp, pressed cranberries, pea fiber, pumpkin, fructooligosaccharides, and psyllium seed husk.

In at least one implementation, the pet food composition further includes a whole grains. The whole grains may include one or more of corn, barley, oats, or combinations thereof. In a preferred implementation, the whole grains include a combination of corn, barley, and oats.

In at least one implementation, the pet food compositions disclosed herein includes protein in an amount of about 30 wt % to about 40 wt %, about 34 wt % to about 38 wt %, or about 36 wt %; fat in an amount of about 15 wt % to about 25 wt %, about 18 wt % to about 22 wt %, or about 20 wt %; total dietary fiber in an amount of about 8 wt % to about 16 wt %, about 10 wt % to about 14 wt %, or about 12 wt %, where the dietary fiber includes soluble fiber and insoluble fiber, and where the soluble fiber is present in an amount of from about 0.5 wt % to about 3.5 wt %, about 1 wt % to about 3 wt %, or about 2 wt %, and the insoluble fiber is present in an amount of from about 7 wt % to about 13 wt %, about 8 wt % to about 12 wt %, or about 10 wt %; omega-6 fatty acids in an amount of from about 1 wt % to about 5 wt %, about 2 wt % to about 4 wt %, or about 3.5 wt %; and omega-3 fatty acids in an amount of about 0.5 wt % to about 1.5 wt %, or about 1.0 wt %; where the omega-3 fatty acid may include EPA and DHA in an amount of from about 0.1 wt % to about 0.5 wt %, about 0.2 wt % to about 0.4 wt %, or about 0.35 wt %. In an exemplary implementation, the pet food composition further includes a mixed fiber source including one or more of ground pecan shells, beet pulp, flaxseed, citrus pulp, pressed cranberries, pea fiber, pumpkin, fructooligosaccharides, psyllium seed husk, or combinations thereof. In a preferred implementation, the mixed fiber source including a combination of ground pecan shells, beet pulp, flaxseed, citrus pulp, pressed cranberries, pea fiber, pumpkin, fructooligosaccharides, and psyllium seed husk. In at least one implementation, the pet food composition further includes a whole grains. The whole grains may include one or more of corn, barley, oats, or combinations thereof. In a preferred implementation, the whole grains include a combination of corn, barley, and oats.

The pet food compositions disclosed herein may be administered or fed to a companion animal. In a preferred implementation, the companion animal may be or include a feline, a canine, or combinations thereof. In a more preferred implementation, the companion animal is a feline or a cat.

### Methods

The present disclosure may provide methods for treating, preventing, and/or inhibiting diarrhea and/or constipation, improving stool characteristics, improving stooling behaviors, improving quality of life of a companion animal, or combinations thereof. As used herein, the term or expression “inhibiting diarrhea and/or constipation” may refer to reducing the severity of diarrhea or constipation. The method may include feeding or administering an effective amount of any one or more of the pet food compositions disclosed herein to the companion animal in need thereof. As used herein, the term or expression “stool characteristics” may include, but are not limited to, stool consistency, stool color, stool odor, amount or presence of blood and/or mucus in stool, or the like, or combinations thereof. As used herein, the term or expression “stooling behaviors” may include, but are not limited to, the frequency of defecation, the frequency of unsuccessful defecation attempts, straining to defecate, vocalizing in pain while attempting to defecate, nausea/vomiting, entering the litterbox without assuming a defecation position, lethargy, defecation accidents, or combinations thereof. As used herein, the term or expression “quality of life” may refer to health-related quality of life (HRQoL), which is different from quality of life considerations related to end of life issues in veterinary medicine. The “quality of life” as used herein was measured using the Cat Health and Wellbeing (CHEW) questionnaire completed by the owner. This questionnaire has been validated and previously published, and is readily available to one having ordinary skill in the art.

### EXAMPLES

The examples and other implementations described herein are exemplary and not intended to be limiting in describing the full scope of compositions and methods of this disclosure. Equivalent changes, modifications and variations of specific implementations, materials, compositions and methods may be made within the scope of the present disclosure, with substantially similar results.

### Example 1

[1] A study was conducted to evaluate the efficacy of a fiber-supplemented control pet food composition (CF) and an exemplary or test pet food composition (TF) according to the compositions disclosed herein for treating, preventing, and/or inhibiting constipation or diarrhea in cats. The test pet food composition included a combination of plant fibers including antioxidant and polyphenol compounds. Features of the control pet food composition (CF) and the test pet food composition (TF) are summarized in Table 1.
[2] A prospective, randomized, controlled, blinded clinical study was conducted with forty-three (43) adult cats diagnosed with constipation or diarrhea, recruited from twenty-two (22) private veterinary practices across the United States. Cats exhibiting clinical signs of diarrhea or constipation were enrolled in the study. The eligibility of each cat was assessed by medical, drug, and dietary histories, physical examination, and laboratory analysis of blood and urine. Cats were excluded from this study if they were under 1 year of age, had systemic disease including kidney disease (IRIS stage 3 or greater), had a Body Fat Index less than 20, were unwilling or unable to exclusively consume the study food, had megacolon or were otherwise unlikely to benefit from a fiber supplemented food, chronically used colonic motility drugs, or were currently receiving oral antibiotics or probiotics and were unwilling to discontinue.

TABLE 1

| | Test Food | Positive Control |
|---|---|---|
| | (TF) | Food (CF) |
| Calculated Nutrient | | |
| Content | | |
| Energy (kcal/kg) | 4086 | 4074 |
| Protein (%) | 36 | 37 |
| Fat (%) | 19 | 21 |
| Total Dietary Fiber | 12 | 5 |
| (%) | | |
| Soluble Fiber (%) | 1.8 | 1.5 |
| Insoluble Fiber (%) | 10.1 | 3.3 |
| Total Omega-6 fatty | 3.5 | 3.8 |
| acids (%) | | |
| Total Omega-3 fatty | 1.0 | 0.2 |
| acids (%) | | |
| EPA + DHA (%) | 0.35 | 0.03 |
| Ingredients | | |
| Mixed Fiber Sources | Ground pecan shells, | Beet pulp, |
| | beet pulp, flaxseed, | fructooligosaccharides, |
| | citrus pulp, pressed | psyllium seed husk |
| | cranberries, pea | |
| | fiber, pumpkin, | |
| | fructooligosaccharides, | |
| | psyllium seed husk | |
| Whole Grains | Corn, Barley, Oats | Corn, Barley |

Enrolled cats were randomized to one of two complete and balanced dry therapeutic foods; a total of 18 cats for the control pet food composition (CF) and 25 cats for the test pet food composition (TF). The 18 cats for the control pet food composition (CF) included 16 with constipation and 2 with diarrhea. The 25 cats for the test pet food composition (TF) included 19 with constipation and 6 with diarrhea. The source of fiber for the control pet food composition (CF) included cracked pearled barley, ground whole grain corn, dried beet pulp, fructooligosaccharides (FOS), and psyllium seed husk. The source of fiber for the test pet food composition (TF) included ground whole grain corn, ground pecan shells, cracked pearled barley, whole grain oats, dried beet pulp, pea fiber, flaxseed, dried citrus pulp, pumpkin, pressed cranberries, FOS, and psyllium seed husk. The test pet food composition (TF) also included relatively greater amounts of insoluble fiber and omega-3 fatty acids. Specifically, the test pet food composition (TF) included insoluble fiber and omega-3 fatty acids in an amount of about 10 wt % and about 1 wt %, respectively, and the control pet food composition (CF) included insoluble fiber an omega-3 fatty acids in an amount of about 3 wt % and about 0.2 wt %, respectively.

Veterinarians performed physical examinations, evaluated clinical signs of constipation or diarrhea, and rated the cat's response to the control (CF) and test (TF) pet food compositions. The veterinarians evaluated the cat's condition and rated the degree of resolution of their GI condition at days 1, 2, 3, 4, and 28, using a defined scale. The scale included the following: Negative Response, Non-Response, Positive Response, and Complete Response. A negative response was defined as an increase compared to the last visit in frequency and/or severity of signs. A non-response was defined as no change compared to the last visit in frequency and/or severity of signs. A positive response was defined as a decrease compared to the last visit in the frequency and/or severity of signs. A complete response was defined as a complete resolution compared to the last visit in frequency and/or severity of signs. This study was reviewed and approved by the Institutional Animal Care & Use Committee, Hill's Pet Nutrition, Inc. Veterinarian evaluations were analyzed using a Cochran-Mantel-Haenszel test with modified ridit scores. Results significant at P<0.05 were reported. The results are summarized in Table 2. Specifically, Table 2 summarizes the number of cats with diarrhea or constipation rated by the veterinarians as either Positive or a Complete Response as compared to the start of the study at each interval of the study. The results are veterinarian-assessed clinical outcomes from cats with either diarrhea or constipation who consumed the indicated food with the duration of the study. The results have been combined across the diseases/conditions.

TABLE 2
Veterinarian-assessed clinical outcomes from cats
with diarrhea or constipation who consumed the
indicated food for the duration of the study
Test Pet Food Composition (TF)

| | Percent of Positive and |
|---|---|
| Day | Complete Response (%)¹ |
| 1 | 0 |
| 2 | 32 |
| 3 | 56 |
| 4 | 65 |
| ≥28 | 96 |

Control Pet Food Composition (CF)

| | Percent of Positive and |
|---|---|
| Day | Complete Response (%)² |
| 1 | 0 |
| 2 | 39 |
| 3 | 56 |
| 4 | 56 |
| ≥28 | 74 |

¹p < 0.0001
²p = Not significant (NS)

As indicated in Table 2, 96% of cats suffering from diarrhea or constipation that were fed the test pet food composition (TF) surprisingly and unexpectedly exhibited either a positive or a complete veterinarian-assessed clinical response as compared to 74% of cats suffering from diarrhea or constipation that were fed the control pet food composition (CF). The effects of the test pet food composition (TF) were most significant after feeding for at least four weeks. As such, 96% of the cats suffering from diarrhea or constipation and fed the test pet food composition (TF) exhibited a positive or complete resolution of clinical signs of diarrhea or constipation. It should be appreciated that the control pet food composition (CF) was a “positive control pet food composition” that was expected to elicit a positive impact on diarrhea and constipation in the cats. Table 2, however, demonstrated that the test pet food composition (TF) was superior in efficacy and the superiority of the test pet food composition (TF) was attributed to features of the test pet food composition (TF) or the type and level combinations of mixed fibers.

The study supports that the test pet food composition (TF) effectively resolved veterinarian-assessed clinical outcomes in cats with either constipation or diarrhea. These results demonstrate that the combination of fiber sources of the test pet food composition (TF), which were rich in antioxidant and anti-inflammatory compounds, were more effective than traditional or conventional fiber sources, as utilized in the control pet food composition (CF), in improving clinical responses in cats with diarrhea or constipation. Further, cats with constipation and diarrhea who received the test pet food composition (TF), when analyzed separately by disease condition, responded similarly to the overall study population, showing improvements in veterinarian-assessed clinical signs over time as shown in Table 2 and 3 (p<0.01 for the test food in each condition).

TABLE 2
Veterinarian-assessed clinical outcomes from cats with diarrhea
who consumed the indicated food for the duration of the study
Test Pet Food Composition (TF)

| | Percent of Positive and |
|---|---|
| Day | Complete Response (%)¹ |
| 1 | 0% |
| 2 | 33% |
| 3 | 67% |
| 4 | 33% |
| ≥28 | 100% |

Control Pet Food Composition (CF)

| | Percent of Positive and |
|---|---|
| Day | Complete Response (%)² |
| 1 | 0 |
| 2 | 0.00% |
| 3 | 50.00% |
| 4 | 50.00% |
| ≥28 | 50.00% |

¹Represents 6 cats (p ≤ 0.01)
²Represents 2 cats (p = Not significant (NS))

TABLE 3
Veterinarian-assessed clinical outcomes from cats with constipation
who consumed the indicated food for the duration of the study
Test Pet Food Composition (TF)

| | Percent of Positive and |
|---|---|
| Day | Complete Response (%)¹ |
| 1 | 0% |
| 2 | 32% |
| 3 | 53% |
| 4 | 76% |
| ≥28 | 94% |

Control Pet Food Composition (CF)

| | Percent of Positive and |
|---|---|
| Day | Complete Response (%)² |
| 1 | 0 |
| 2 | 44% |
| 3 | 56% |
| 4 | 56% |
| ≥28 | 76% |

¹Represents 19 cats (p ≤ 0.01)
²Represents 16 cats (p = Not significant (NS))

### Example 2

A study was conducted to evaluate the efficacy of the test pet food composition (TF) of Example 1 for reducing blood in stool of cats suffering from constipation. It should be appreciated by one having ordinary skill in the art that healthy cats without constipation or diarrhea do not typically have blood in their stool. Cats with constipation often strain to defecate and the movement of hard dry stool in the lower colon may irritate these tissues and cause bleeding within the colon mucosal lining and this blood adheres to the stool as it is passed. Diarrhea on the other hand can also cause irritation and cause bleeding in the intestines. Further, inflammation in the intestines can result in malabsorption (and thus, diarrhea) as well as bleeding. As constipation is resolved there is less straining and the stool is not as hard and dry, which then does not irritate the colon mucosa lining and when diarrhea begins to resolve the blood is not evident on the stool as it is passed. Less blood in the stool is an indicator that the constipation and diarrhea is resolving or resolved and that the cat is in a healthier state.

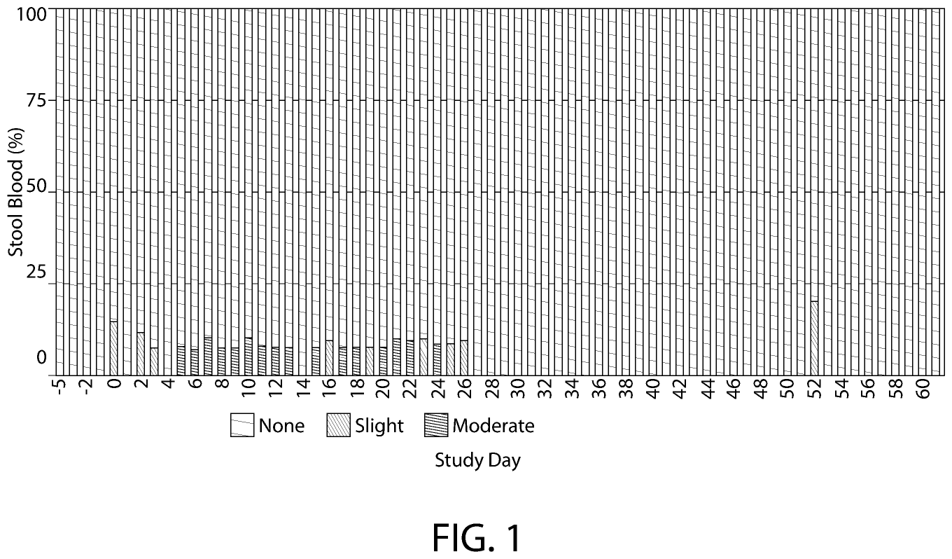

The study was conducted for a period of about two months. As is typical in clinical trials, scheduling of the last visit may extend a time beyond the two month period. The results are illustrated in FIG. 1. As illustrated in FIG. 1, although the majority of the cats did not have blood in stool, a noticeable reduction in frequency of blood in the stool during the study was observed. The effects were more significant or noticeable the longer the duration the cats were fed the test pet food composition (TF).

### Example 3

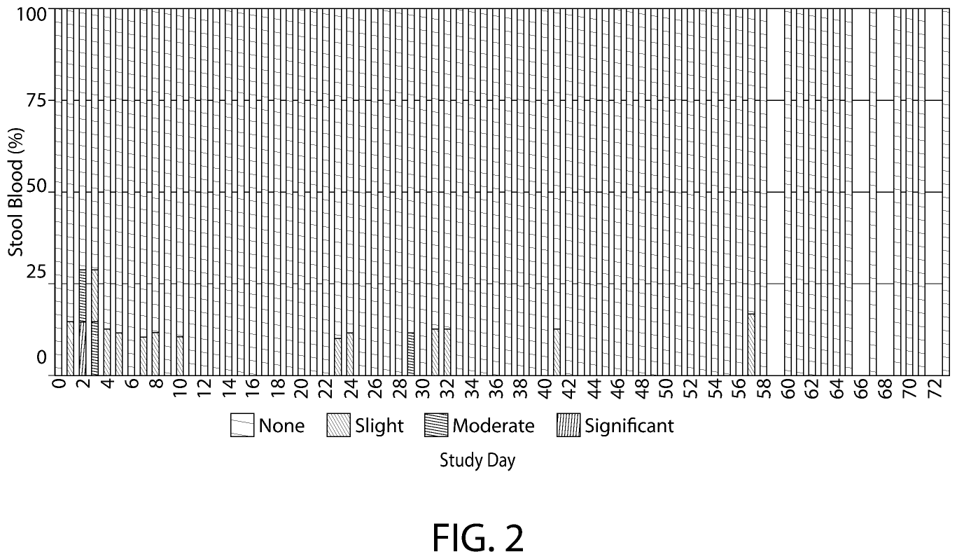

A study was conducted to evaluate the efficacy of the test pet food composition (TF) of Example 1 for reducing blood in stool of cats suffering from diarrhea. The study was conducted for a period of about two months. As is typical in clinical trials, scheduling of the last visit may extend a time beyond the two month period. The results are illustrated in FIG. 2.

Although the majority of cats did not have blood in stool, a noticeable reduction in frequency of blood in the stool during the study was observed. The effects were more significant or noticeable the longer the duration the cats were fed the test pet food composition (TF).

### Example 4

A study was conducted to evaluate the efficacy of the test pet food composition (TF) of Example 1 for reducing mucus in stool of cats suffering from constipation. It should be appreciated by one having ordinary skill in the art that healthy cats without constipation or diarrhea do not typically have blood in their stool. Cats with constipation often strain to defecate and the movement of hard dry stool in the lower colon may irritate these tissues and cause bleeding within the colon mucosal lining and this blood adheres to the stool as it is passed. Diarrhea can also cause irritation to intestinal lining and mucus is produced to help insulate or protect the intestinal mucosa. As constipation or diarrhea is resolved, there is less hard and dry stool or less diarrhea, which does not evoke the production of mucus. As such, less mucus in the stool is an indicator that the constipation or diarrhea is resolving or resolved and that the cat is in a healthier state.

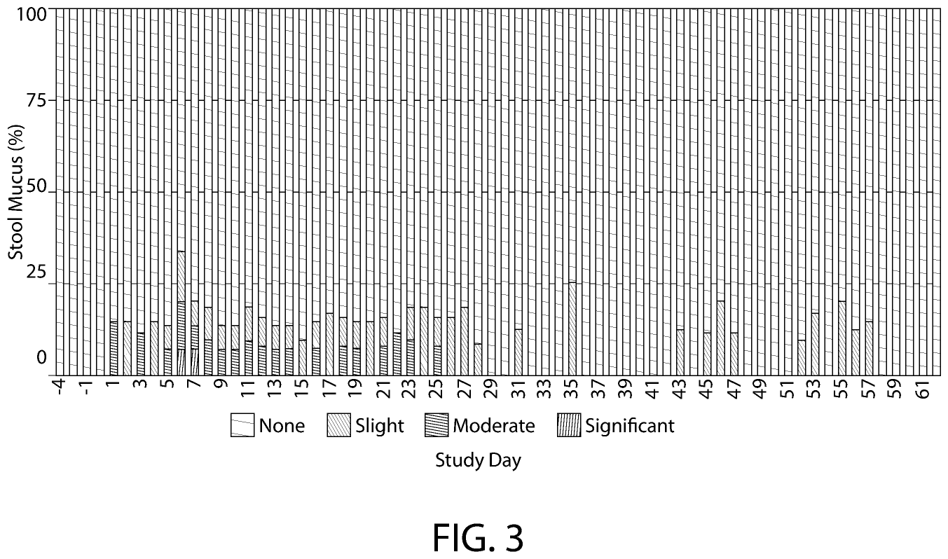

The study was conducted for a period of about two months. The results are illustrated in FIG. 3. Although the majority of cats did not have mucus in stool, a noticeable reduction in frequency of mucus in the stool during the study was observed. The effects were more significant or noticeable the longer the duration the cats were fed the test pet food composition (TF).

### Example 5

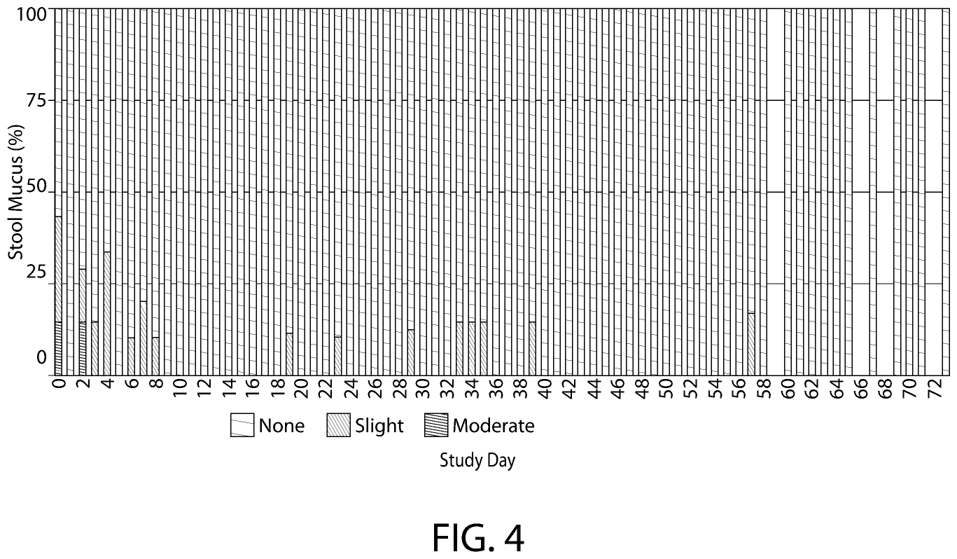

A study was conducted to evaluate the efficacy of the test pet food composition (TF) of Example 1 for reducing mucus in stool of cats suffering from diarrhea. The study was conducted for a period of about two months. As is typical in clinical trials, scheduling of the last visit may extend a time beyond the two month period. The results are illustrated in FIG. 4.

Although the majority of cats did not have mucus in stool, a noticeable reduction in frequency of mucus in the stool during the study was observed. The effects were more significant or noticeable the longer the duration the cats were fed the test pet food composition (TF).

### Example 6

A study was conducted to evaluate the efficacy of the test pet food composition (TF) and the control pet food composition (CF) of Example 1 for improving stooling behavior in cats suffering from constipation. The study was conducted for a period of 56 days. The study was conducted via a behavioral questionnaire taken at the beginning of the study (day 1) and at the end of the study (day 56). The focus of the behavioral questionnaire is indicated in Tables 4 and 5 for the test and control pet food compositions, respectively. The results of the study are summarized in Tables 4 and 5 for the test and control pet food compositions, respectively. It should be appreciated that a reduction in value represents a reduction in the behavior, which is an indicator of an improvement in the condition.

TABLE 4
Owner-assessed clinical outcomes from cats with diarrhea or constipation
who consumed the Test food for the duration of the study

| | Day 14 | Day 28 | Day 56 |
|---|---|---|---|
| Behavior | (%) | (%) | (%) |
| Frequency of Entering Litterbox | 22.6 | 11.1 | 15.2 |
| Without Assuming the Defecation | | | |
| Posture | | | |
| Frequency of Acting Nauseated | 10.8 | 12.0 | 5.4 |
| and/or Vomiting | | | |
| Frequency Of Defecation Accidents | 9.2 | 5.1 | 4.5 |
| Frequency Of Acting Lethargic | 19.0 | 18.3 | 11.1 |
| Frequency Of Making Unproductive | 15.7 | 12.0 | 5.2 |
| Attempts To Defecate | | | |
| Frequency Of Straining To Defecate | 15.5 | 16.7 | 13.9 |
| Frequency Of Vocalizing In Pain | 8.8 | 7.9 | 5.8 |
| When Attempting To Defecate | | | |

TABLE 5
Owner-assessed clinical outcomes from cats with diarrhea or constipation
who consumed the Control food for the duration of the study

| | Day 14 | Day 28 | Day 56 |
|---|---|---|---|
| Behavior | (%) | (%) | (%) |
| Frequency of Entering Litterbox | 13.4 | 15.1 | 11.9 |
| Without Assuming the Defecation | | | |
| Posture | | | |
| Frequency of Acting Nauseated | 14.0 | 16.0 | 16.9 |
| and/or Vomiting | | | |
| Frequency Of Defecation Accidents | 26.0 | 24.5 | 24.3 |
| Frequency Of Acting Lethargic | 20.6 | 18.5 | 16.9 |
| Frequency Of Making Unproductive | 29.2 | 26.8 | 23.5 |
| Attempts To Defecate | | | |
| Frequency Of Straining To Defecate | 33.4 | 28.9 | 31.1 |
| Frequency Of Vocalizing In Pain | 12.0 | 10.3 | 11.7 |
| When Attempting To Defecate | | | |

As indicated in Table 4, a noticeable decrease in the GI-condition-related stooling behavior was observed in cats fed the test pet food composition (TF). Further, as indicated in Table 5, a noticeable decrease in the GI-condition-related stooling behavior was not observed in cats fed the positive control pet food composition (CF).

The present disclosure has been described with reference to exemplary implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof. Moreover, although specific terms may be employed herein, as well as in the claims which follow, they are used only in a generic and descriptive sense, and not for the purposes of limiting the disclosure, nor the claims that follow.

1. A pet food composition comprising:
psyllium or a derivative thereof;
a polyphenol source;
a high solubility fiber source; and
a low solubility fiber source.

2. The pet food composition according to claim 1, wherein the psyllium or derivative thereof, is present in an amount of from about 0.1 wt % to about 5 wt % based on the total weight of the pet food composition.

3. The pet food composition according to claim 1, wherein the high solubility fiber source comprises one or more of oat bran, buckwheat groats, barley, tomato pomace, citrus pulp, beet pulp, or combinations thereof.

4. The pet food composition according to claim 1, wherein the low solubility fiber source comprises one or more of a cellulosic material, a pecan fiber, or combinations thereof.

5. The pet food composition according to claim 1, comprising from about 30 wt % to about 55 wt % protein.

6. The pet food composition according to claim 1, comprising from about 5 wt % to about 15 wt % total dietary fiber.

7. The pet food composition according to claim 1, wherein a weight ratio of insoluble fiber to soluble fiber is from about 10:1 to about 1:1.

8. The pet food composition according to claim 1, further comprising a mixture of omega-6 fatty acids and omega-3 fatty acids.

9. The pet food composition according to claim 8, wherein the weight ratio of the omega-6 fatty acids to the omega-3 fatty acids is from about 10:1 to about 1:1.

10. The pet food composition according to claim 8, wherein the omega-3 fatty acids comprise from about 0.1 wt % to about 0.5 wt % docosahexaenoic acid (DHA), eicosapentaenoic acid (EPA), or a mixture thereof.

11. The pet food composition according to claim 8, wherein the omega-3 fatty acids are provided by flaxseed.

12. The pet food composition according to claim 1, wherein the polyphenol source provides a polyphenol selected from one or more of dehydroxy rosmarinic acid, Coumaroylnepitrin, eupafolin, carnosol, scutellarin, kaempferol, rosmarinic acid, rosmanol, cirsimaritin, luteolin, 6-methoxy-luteolin, 7-epirosmannol, quercetin, catechin, hesperidin, cyanidin, or combinations thereof.

13. The pet food composition according to claim 1, wherein the polyphenol source comprises pressed cranberries, cranberry pomace, or combinations thereof.

14. The pet food composition according to claim 1, wherein the composition is substantially free of pea fiber.

15. The pet food composition according to claim 1, further comprising pumpkin.

16. The pet food composition according to claim 1, further comprising a probiotic.

17. The pet food composition according to claim 16, wherein the probiotic comprises one or more of Bifidobacterium lactis; Bifidobacterium animalis; Lactobacillus acidophilus; Bifidobacterium longum; Enterococcus faecium; or combinations thereof.

18. The pet food composition according to claim 1, further comprising a prebiotic.

19. The pet food composition according to claim 18, wherein the prebiotic comprises a fructooligosaccharide.

20. A method for:
treating, inhibiting, or preventing diarrhea or constipation;
improving stool characteristics;
improving stooling behaviors; and/or
improving quality of life in a companion animal, comprising:
administering an effective amount of the pet food composition of claim 1 to the companion animal in need thereof.
